(19) United States
(12) Patent Application Publication
(10) Pub. No.: US 2009/0175743 A1
(43) Pub. Date: Jul. 9, 2009

(54) Compressor and manufacturing method of the same

(75) Inventors: Yasuo Sakamoto, Gunma-ken (JP); Kazuyoshi Sugimoto, Gunma-ken (JP); Yoshiaki Koike, Ota-shi (JP); Shinya Itabashi, Ota-shi (JP)

Correspondence Address: KRATZ, QUINTOS & HANSON, LLP, 1420 K Street, N.W., Suite 400, WASHINGTON, DC, 20005, US

(73) Assignee: SANYO ELECTRIC CO., LTD., Moriguchi-shi (JP)

(21) Appl. No.: 12/007,086

(22) Filed: Jan. 7, 2008

(51) Int. Cl. F04B 39/00; F16J 15/08; F04B 53/22; F04B 35/04

(52) U.S. Cl. 417/415; 277/650; 277/595; 29/888.02

(57) ABSTRACT

There is disclosed a compressor capable of easily adjusting top clearances in a case where metal gaskets are used as a seal material between a valve plate and a casing main body. In the compressor in which pistons reciprocate in cylinders of the casing main body constituting a casing to perform a compression work and which is constituted by fixing cylinder heads with bolts to the casing main body via the seal material and the valve plate, the seal material to be interposed between the valve plate and the casing body is constituted by superimposing a plurality of metal gaskets on one another.

### BACKGROUND OF THE INVENTION

The present invention relates to a compressor which is constituted by fixing cylinder heads to a casing main body with bolts and which allows pistons to reciprocate, thereby performing a compression work, and it also relates to a manufacturing method of the compressor.

Heretofore, in a reciprocation type semi-sealed compressor which allows pistons to reciprocate in cylinders, thereby performing a compression work of a refrigerant, a valve plate and cylinder heads are fixed with bolts to a casing main body to constitute a casing. Moreover, seal materials are interposed between the cylinder head and the valve plate and between the valve plate and the casing main body to seal among members (e.g., see Japanese Patent Application Laid-Open No. 2004-301071).

In this case, a gasket made of asbestos has heretofore been used usually as the seal material. In such a reciprocation type compressor, top clearances of the pistons (clearances between the cylinders and the valve plate) are an important element. Here, the gasket made of asbestos has a low plate thickness precision, and hence even when the gaskets are manufactured in an equal plate thickness, actual plate thicknesses vary. To solve the problem, in a case where the compressor is assembled, the gaskets of asbestos are ranked in accordance with each actual plate thickness, and the gasket to be interposed between the valve plate and the casing main body is selected for use from these ranks, whereby the top clearances of the pistons are adjusted.

However, in recent years, an asbestos material cannot be used owing to a problem of adverse influence on a human body, and a metal gasket constituted of a cold rolled steel plate, a stainless steel plate or the like as disclosed in the above patent document has to be used as the gasket for such a compressor.

In addition, the metal gasket has a remarkably high plate thickness precision as compared with the asbestos gasket, and it is therefore difficult to rank the gaskets with the equal plate thickness as described above. Moreover, such a metal gasket is provided with beads to increase a pressure contact strength and accordingly obtain a necessary seal surface pressure, but when the metal gasket is formed into a thickness dimension similar to that of the asbestos gasket, it might be impossible or remarkably difficult to process the beads.

### SUMMARY OF THE INVENTION

The present invention has been developed in order to solve such a conventional technical problem, and an object thereof is to provide a compressor capable of easily adjusting top clearances in a case where a metal gasket is used as a seal material between a valve plate and a casing main body, and a manufacturing method of the compressor.

In a compressor according to the present invention of a first aspect, pistons reciprocate in cylinders of a casing main body constituting a casing, to perform a compression work, the compressor is constituted by fixing cylinder heads with bolts to the casing main body via a seal material and a valve plate, and the compressor is characterized in that the seal material to be interposed between the valve plate and the casing main body is constituted by superimposing a plurality of metal gaskets on one another.

The compressor according to the present invention of a second aspect is characterized in that in the above invention, among the plurality of metal gaskets, a first metal gasket is provided with beads, and a second metal gasket is not provided with any bead.

The compressor according to the present invention of a third aspect is characterized in that in the above invention, both the metal gaskets are superimposed on each other so that crests of the beads of the first metal gasket are disposed on the side of the second metal gasket.

The compressor according to the present invention of a fourth aspect is characterized in that in the above invention of the second or third aspect, both the metal gaskets are superimposed on each other so that the second metal gasket is disposed on the side of the valve plate, and the first metal gasket is disposed on the side of the casing main body.

The compressor according to the present invention of a fifth aspect is characterized in that in the above invention of the second to fourth aspects, the first metal gasket is provided with two inner and outer strings of beads.

The compressor according to the present invention of a sixth aspect is characterized in that in the above invention of the second to fifth aspects, the metal gaskets are provided with suction holes corresponding to a suction port of the valve plate, and the first metal gasket is provided with beads which connect the two inner and outer strings of beads to each other outside the suction holes.

The compressor according to the present invention of a seventh aspect is characterized in that in the invention of the second to sixth aspects, the metal gaskets are provided with discharge holes corresponding to a discharge port of the valve plate, and bolt holes through which the bolts extend, and the first metal gasket is provided with the beads around the discharge holes and the bolt holes.

The compressor according to the present invention of an eighth aspect is characterized in that in the above invention, the beads around the bolt holes are formed in portions corresponding to inner sides from outer edges of heads of the bolts.

A manufacturing method of a compressor according to the present invention of a ninth aspect is a manufacturing method of a compressor in which pistons reciprocate in cylinders of a casing main body constituting a casing to perform a compression work and which is constituted by fixing cylinder heads with bolts to the casing main body via a seal material and a valve plate, characterized by comprising: superimposing a plurality of metal gaskets on one another to constitute the seal material to be interposed between the valve plate and the casing main body; and selecting one or the plurality of metal gaskets for use from gaskets having a plurality of plate thicknesses, to adjust top clearances of the pistons.

The manufacturing method of the compressor according to the present invention of a tenth aspect is characterized in that in the above invention, the metal gasket having the plate thickness selected for the adjustment of the top clearances is not provided with any bead, and a metal gasket other than the metal gasket is provided with beads.

According to the present invention of the first or ninth aspect, the seal material to be interposed between the valve plate and the casing main body is constituted of the plurality of metal gaskets, and one or the plurality of metal gaskets are selected for use from the metal gaskets having the plurality of plate thicknesses, whereby the top clearances of the pistons can remarkably easily be adjusted.

In particular, when one of the plurality of metal gaskets, that is, the first metal gasket is provided with the beads and another metal gasket, that is, the second metal gasket is not provided with any bead as in the present invention of the second and tenth aspects, the metal gasket having such a plate thickness that the beads can easily be formed is used as the first metal gasket, and the top clearances can be adjusted by selecting the plate thickness of the second metal gasket. In consequence, while easily adjusting the top clearances by use of the metal gasket, the bead can be processed without any trouble to secure a seal property. Especially, the top clearances are adjusted by selecting the plate thickness of the second metal gasket which is not provided with any bead, not the first metal gasket provided with the beads, so that the plate thickness of the first metal gasket does not have to be reduced. That is, the plate thickness of the first metal gasket can be secured to maintain such a sufficient spring constant that a predetermined surface pressure can be obtained, and the surface pressure can be set to be constant to improve the seal property. Moreover, a degree of freedom in the plate thickness of each metal gasket increases, so that a complicated shape can easily be achieved, and replacement and maintenance can easily be performed.

Moreover, in a case where both the metal gaskets are superimposed on each other so that crests of the beads of the first metal gasket are disposed on the side of the second metal gasket as in the present invention of the third aspect, the crests of the beads of the first metal gasket abut on the second metal gasket. Therefore, a pressure contact strength between both the metal gaskets increases, and the seal property therebetween can be improved, as compared with a case where roots of the beads are allowed to abut on the second metal gasket.

Furthermore, in a case where both the metal gaskets are superimposed on each other so that the second metal gasket is disposed on the side of the valve plate and the first metal gasket is disposed on the side of the casing main body as in the present invention of the fourth aspect, the first metal gasket provided with the beads comes in contact under pressure with the casing main body having a low surface precision, so that a satisfactory seal property between the metal gasket and the casing main body can be secured.

In addition, when the first metal gasket is provided with two inner and outer strings of beads as in the present invention of the fifth aspect, a portion of the metal gasket having a high pressure contact strength can doubly be constituted outside the cylinders, and the seal property between the valve plate and the casing main body can further be improved.

Moreover, when beads which connect the two inner and outer strings of beads to each other are formed outside the suction hole of the first metal gasket corresponding to the suction port of the valve plate as in the present invention of the sixth aspect, at a suction port portion having a small pressure, shapes of the beads can be simplified to improve a processing property.

On the other hand, in a case where the beads are formed around the discharge hole of the first metal gasket corresponding to the discharge port of the valve plate and the bolt holes through which the bolts extend as in the present invention of the seventh aspect, a seal property between a discharge port portion where a pressure increases and a bolt portion can be secured.

In particular, in a case where the beads around the bolt holes are formed in the portions corresponding to the inner sides from the outer edges of the heads of the bolts as in the present invention of the eighth aspect, the beads fall in a range in which the bolts are fastened, and the seal property around the bolts can further be improved.

### BRIEF DESCRIPTION OF THE DRAWINGS

FIG. 1 is a plan view of a semi-sealed compressor according to an embodiment to which the present invention is applied (Embodiment 1);

FIG. 2 is a vertical front view of the compressor of FIG. 1;

FIG. 3 is a partially vertical side view of the compressor of FIG. 1;

FIG. 4 is an exploded vertical front view of the compressor of FIG. 1;

FIG. 5 is an exploded partially vertical side view of the compressor of FIG. 1;

FIG. 6 is a plan view of a first metal gasket to be attached to the compressor of FIG. 1;

FIG. 7 is a diagram showing a bead pattern of the first metal gasket of FIG. 6;

FIG. 8 is an enlarged plan view of the first metal gasket of FIG. 6;

FIG. 9 is a sectional view of a bead portion of the first metal gasket of FIG. 6;

FIG. 10 is a sectional view of a bolt hole portion of the first metal gasket of FIG. 6;

FIG. 11 is a plan view of a second gasket to be attached to the compressor of FIG. 1; and

FIG. 12 is an exploded partially vertical side view of a semi-sealed compressor according to another embodiment of the present invention (Embodiment 2).

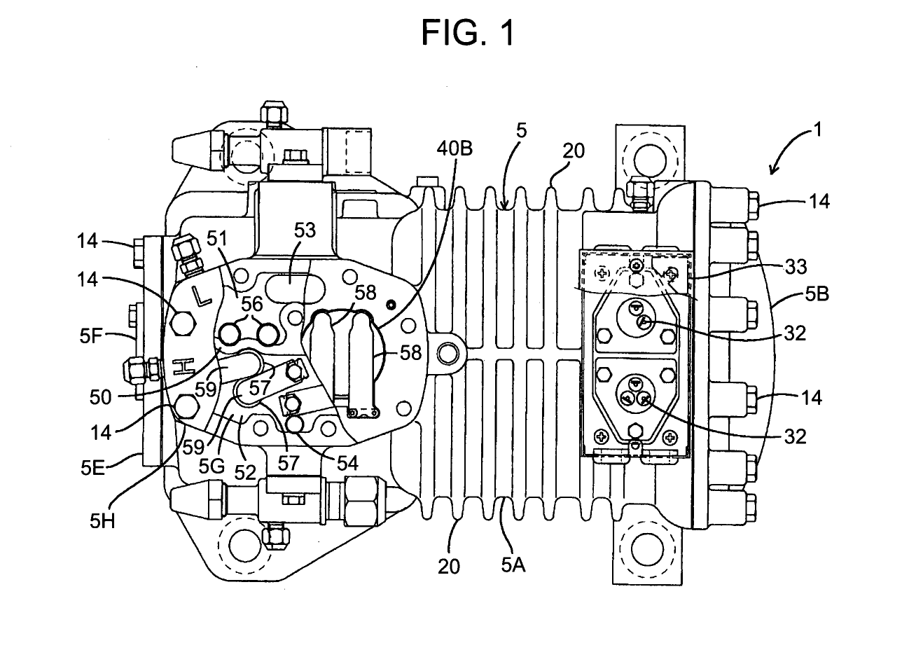

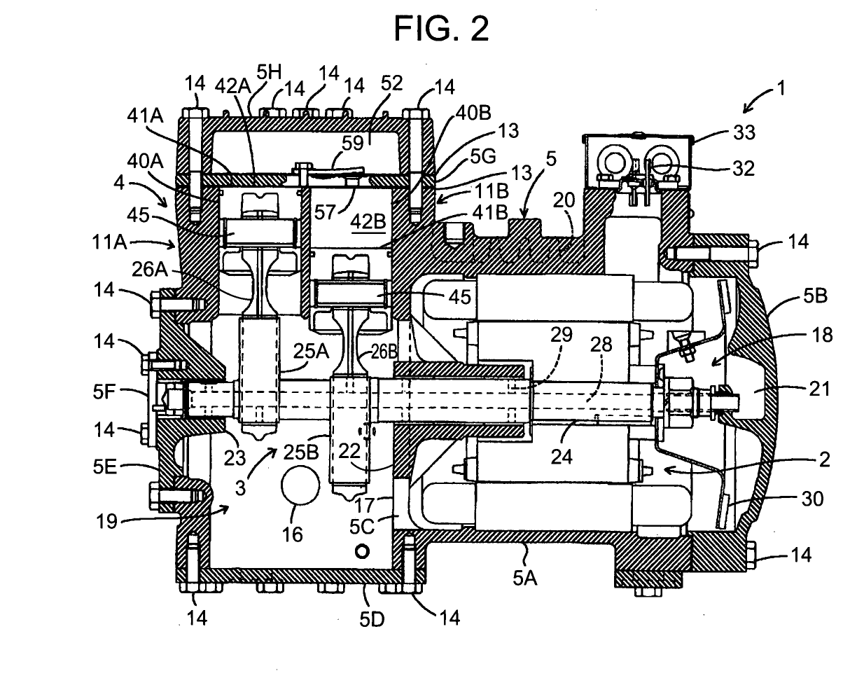

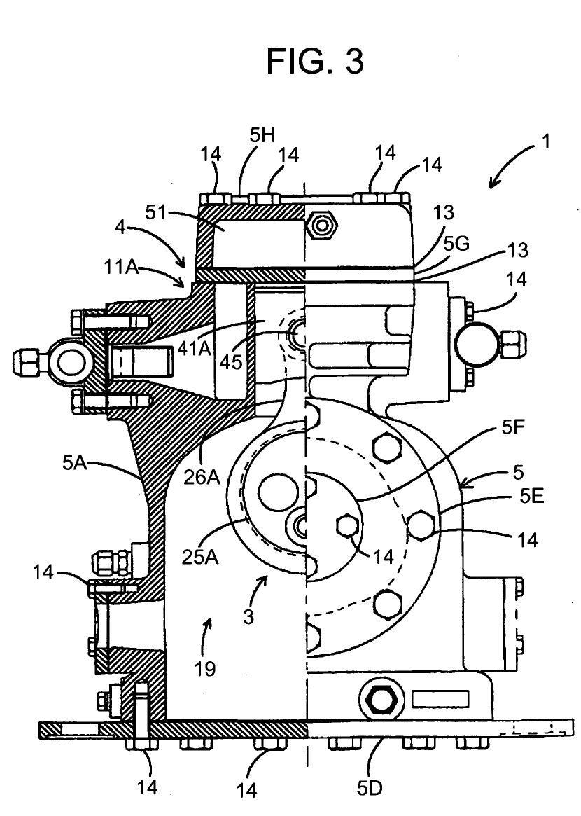

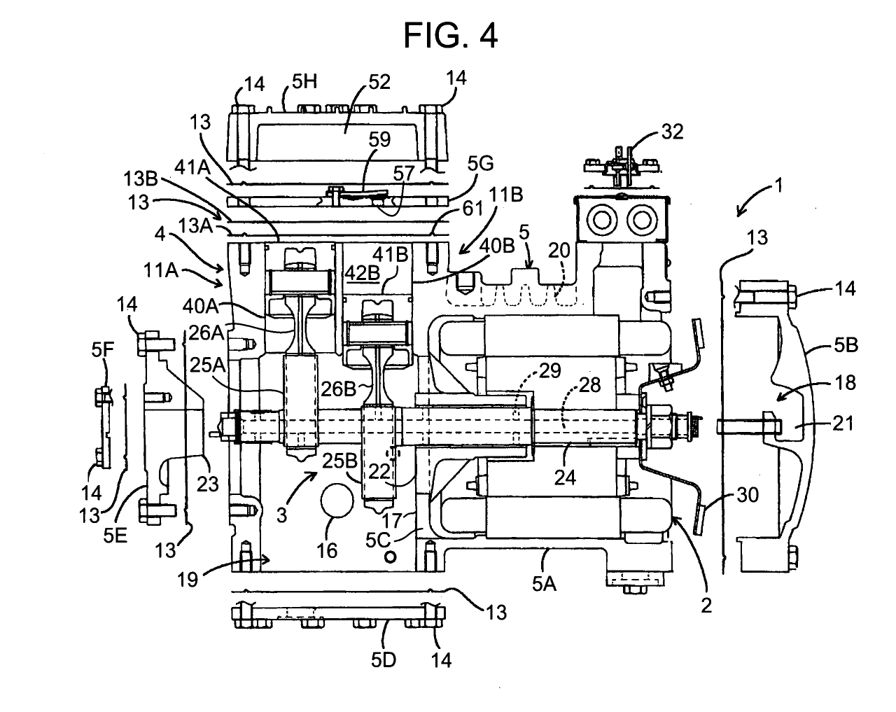

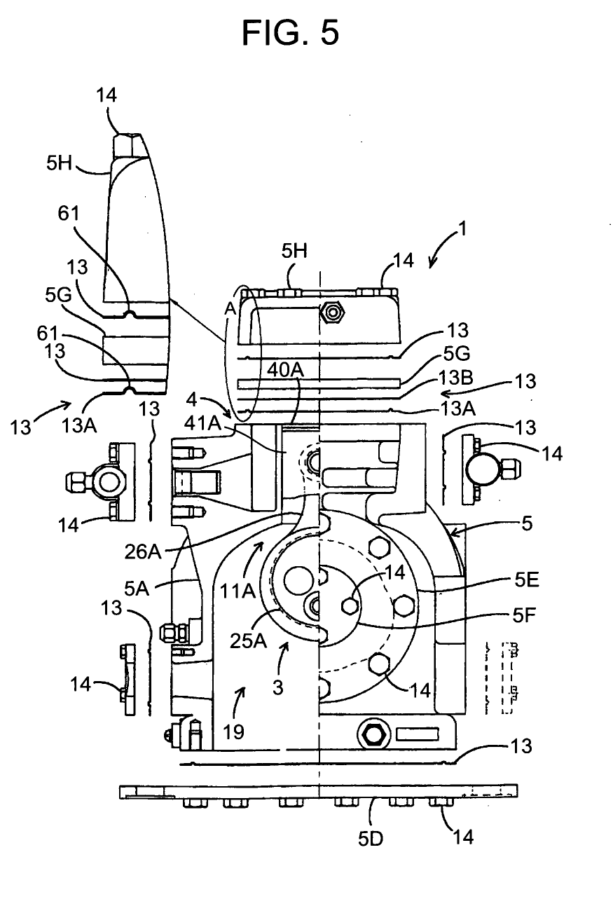

### DETAILED DESCRIPTION OF THE PREFERRED EMBODIMENTS

Embodiments of the present invention will hereinafter be described in detail with reference to the drawings.

### Embodiment 1

A compressor 1 of an embodiment is constituted of a motor (driving element) 2 which generates a rotation power, power conversion means 3 for converting the rotation power generated by this motor 2 into a reciprocation power, compression means 4 driven by the reciprocation power converted by this power conversion means 3 to compress a refrigerant (e.g., a natural refrigerant such as carbon dioxide, R-134a, R-22 or the like), a casing 5 in which these components are received and the like. It is to be noted that the compression means 4 of the embodiment has a two-cylinder constitution of a first compressing section 11A and a second compressing section 11B.

The casing 5 is constituted of a casing main body 5A formed of a material of spherical graphite cast iron or the like, a motor side lid 5B, a partition plate 5C, a bottom lid 5D, a crank side lid 5E, a shaft lid 5F, a valve plate 5G, a cylinder head 5H and the like. These members are fastened with a plurality of bolts 14, fixed to the casing main body 5A via a seal material 13 and assembled in a sealed state.

It is constituted that a lubricant oil for lubricating slide portions of the compressor 1 is stored in a bottom part of the casing main body 5A and that an oil amount can be confirmed through sight glass (a see-through window) 16. An inner space of the casing main body 5A is separated into a motor chamber 18 and a crank chamber 19 by the partition plate 5C. The partition plate 5C is provided with a plurality of through holes 17, and an atmosphere and the lubricant oil can reciprocate between the motor chamber 18 and the crank chamber 19 via the through holes 17.

Moreover, an outer side surface of the casing main body 5A corresponding to the motor chamber 18 is provided with a large number of casing fins 20, and it is constituted that heat is efficiently released from the casing 5. Furthermore, the motor side lid 5B is provided with a lubricant oil pocket 21, the partition plate 5C is provided with a main journal 22, and the crank side lid 5E is provided with a sub-journal 23.

The power conversion means 3 includes cranks 25A, 25B which are formed integrally with a motor shaft 24 of the motor 2 and which eccentrically rotate with respect to a shaft center of the motor shaft 24 to convert the rotation power into the reciprocation power, connecting rods 26A, 26B connected to these cranks 25A, 25B, respectively, and the like. It is to be noted that the crank 25A and the connecting rod 26A are provided so as to correspond to the first compressing section 11A, and the crank 25B and the connecting rod 26B are provided so as to correspond to the second compressing section 11B.

The motor 2 is a canned motor engaged with and attached to the motor chamber 18, and a hole having a predetermined diameter is made in the shaft center of the motor shaft 24 to constitute a main lubricant oil path 28. The motor shaft 24 is also provided with a sub lubricant oil path 29 which constitutes a lubricant path of the lubricant oil to large ends and small ends of the connecting rods 26A, 26B, and a lubricant path of the lubricant oil to the main journal 22 and the sub-journal 23.

Moreover, one end of this motor shaft 24 is inserted into the lubricant oil pocket 21 from a side surface of the lubricant oil pocket 21, and the other end thereof is inserted through the main journal 22, engaged with the sub-journal 23 provided on the crank side lid 5E, and rotatably supported by the main journal 22 and the sub-journal 23.

Furthermore, a lubricant oil scrape-up blade 30 is attached to a rotor of the motor 2, and configured to rotate together with the motor shaft 24. In consequence, when the lubricant oil scrape-up blade 30 rotates with the rotation of the motor 2, the lubricant oil stored in the bottom part of the casing 5 is attached to the lubricant oil scrape-up blade 30, and scraped up, and at this time, the lubricant oil which has dropped down is accumulated in the lubricant oil pocket 21. The motor shaft 24 is inserted through this lubricant oil pocket 21, and this motor shaft 24 is provided with the main lubricant oil path 28, whereby the lubricant oil accumulated in the lubricant oil pocket 21 flows into the main lubricant oil path 28 to flow toward the crank side lid 5E.

The lubricant oil which has flowed into the main lubricant oil path 28 receives a centrifugal force owing to the rotation of the motor shaft 24, is branched into the sub lubricant oil path 29, and supplied to slide surfaces of the main journal 22, the sub-journal 23, the large and small ends of the connecting rods 26A, 26B and the like. It is to be noted that the lubricant oil is also supplied between pistons and cylinders constituting the compression means 4 as described later, to improve air tightness of the compression chamber. Then, the lubricant oil which has not been used in lubricating the slide portions (a remaining lubricant oil) is discharged from a lubricant oil return path (not shown) formed in the crank side lid 5E to return to the bottom part of the casing 5.

Moreover, the casing main body 5A at a position above the motor 2 is provided with a connection terminal box 33 in which a connection terminal 32 for supplying a power to the motor 2 is received.

The compression means 4 has the first compressing section 11A and the second compressing section 11B as described above, the compressing sections 11A, 11B are constituted of a first cylinder 40A and a second cylinder 40B formed in the casing main body 5A, and a first piston 41A and a second piston 41B which reciprocate in the cylinders 40A, 40B, respectively, and the cylinders 40A, 40B and the pistons 41A, 41B constitute a first compression chamber 42A and a second compressor 42B, respectively.

It is to be noted that a phase of the reciprocation of the piston 41A deviates as much as 180 degrees from that of the reciprocation of the piston 41B, and it is constituted that when the piston 41A lowers (refrigerant suction), the piston 41B rises to compress the refrigerant. In consequence, a load to be applied to the motor 2 is uniformed. Moreover, in the embodiment, diameters and reciprocation distances (bores and strokes) of the pistons 41A, 41B are set to be equal. In consequence, in the embodiment, displacement volumes of the compressing sections 11A, 11B are set to be equal. Furthermore, the pistons 41A, 41B are connected to the small ends of the connecting rods 26A, 26B swingably via pins 45, and reciprocate owing to the reciprocation powers of the connecting rods 26A, 26B, respectively.

The cylinder head 5H is a dish-like member, and an inner space of the head is separated into a suction chamber 51 and a discharge chamber 52 by a partition wall 50. The suction chamber 51 is a space to which a refrigerant from the outside is supplied, and the refrigerant of the suction chamber 51 is supplied to the compression chambers 42A, 42B. The discharge chamber 52 is a chamber to which the refrigerant compressed by the compression chambers 42A, 42B is discharged, and this refrigerant is supplied from the compressor.

At this time, the valve plate 5G corresponding to the suction chamber 51 and the discharge chamber 52 is provided with a suction port 53 and a discharge port 54, respectively. The valve plate 5G is provided with two suction holes 56 corresponding to the suction chamber 51 and two suction holes corresponding to the cylinders 40A, 40B, respectively, and further provided with two discharge holes 57 corresponding to the discharge chamber 52 and two discharge holes corresponding to the cylinders 40A, 40B, respectively.

Moreover, suction valves 58 are provided so as to block the suction holes 56, and discharge valves 59 are provided so as to block the discharge holes 57. Each valve is a leaf-spring-like valve, the suction valves 58 are attached to the surface of the valve plate 5G on the side of the compression chambers 42A, 42B, and the discharge valves 59 are attached to the surface of the valve plate 5G on the side of the discharge chamber 52. The respective valves perform a function of a check valve for allowing the refrigerant to flow in one direction.

In such a constitution, the motor 2 rotates, whereby the cranks 25A, 25B eccentrically rotate with respect to the motor shaft 24, and the connecting rods 26A, 26B connected to the cranks 25A, 25B reciprocate. The connecting rods 26A, 26B are connected to the pistons 41A, 41B. When the piston 41A lowers, a space volume of the compression chamber 42A is expanded to generate a suction pressure (a negative pressure), the suction valve 58 opens owing to this suction pressure, and the refrigerant from the outside enters the suction chamber 51 from the suction port 53, and flows from the suction chamber into the compression chamber 42A via the suction hole 56. When the piston 41A rises, the compression chamber 42A is reduced to compress the refrigerant in the chamber (a compression work). When a pressure of the refrigerant becomes a predetermined pressure, the discharge valve 59 opens, and the refrigerant is discharged from the discharge hole 57 into the discharge chamber 52.

When the piston 41B similarly lowers with a phase difference of 180 degrees, a space volume of the compression chamber 42B is expanded to generate a suction pressure (a negative pressure), the suction valve 58 opens owing to this suction pressure, and the refrigerant from the outside enters the suction chamber 51 from the suction port 53, and flows from the suction chamber into the compression chamber 42B via the suction hole 56. When the piston 41B rises, the compression chamber 42B is reduced to compress the refrigerant in the chamber. When the pressure of the refrigerant becomes the predetermined pressure, the discharge valve 59 opens, and the refrigerant is discharged from the discharge hole 57 into the discharge chamber 52. Then, the refrigerant compressed by the compression chambers 42A, 42B and discharged into the discharge chamber 52 is discharged from the compressor via the discharge port 54.

Next, the seal material 13 interposed between the valve plate 5G and the casing main body 5A will be described. As described above, the members constituting the casing 5 are assembled to the casing main body 5A with the bolts 14 via the seal material 13. In this case, with regard to assembled parts of the cylinder head 5H, the valve plate 5G and the casing main body 5A, the seal material 13 is interposed between the cylinder head 5H and the valve plate 5G, and the seal material 13 is also interposed between the valve plate 5G and the casing main body 5A. Each seal material 13 interposed between the members is a plate material constituted by coating the surface of a metal plate such as a cold rolled steel plate (SPCC) or a stainless steel plate (SUS316) with an elastic material such as a nitrile rubber (NBR) having resistances to high temperature, high pressure and oil.

Here, the seal material 13 interposed between the valve plate 5G and the casing main body 5A performs a function of adjusting the top clearances of the cylinders 40A, 40B, that is, the clearances between the pistons 41A, 41B and the valve plate 5G. Therefore, heretofore, a gasket made of asbestos is used as the seal material 13. For example, gaskets manufactured in a thickness of 0.8 t are ranked into three stages of thicknesses in accordance with fluctuations, and one gasket is selected from them to adjust the top clearances. However, the gasket of asbestos cannot be used. Therefore, in the present invention, a plurality of metal gaskets, that is, two metal gaskets (a first metal gasket 13A and a second metal gasket 13B) in the embodiment are superimposed on each other to constitute the seal material 13 between the valve plate 5G and the casing main body 5A.

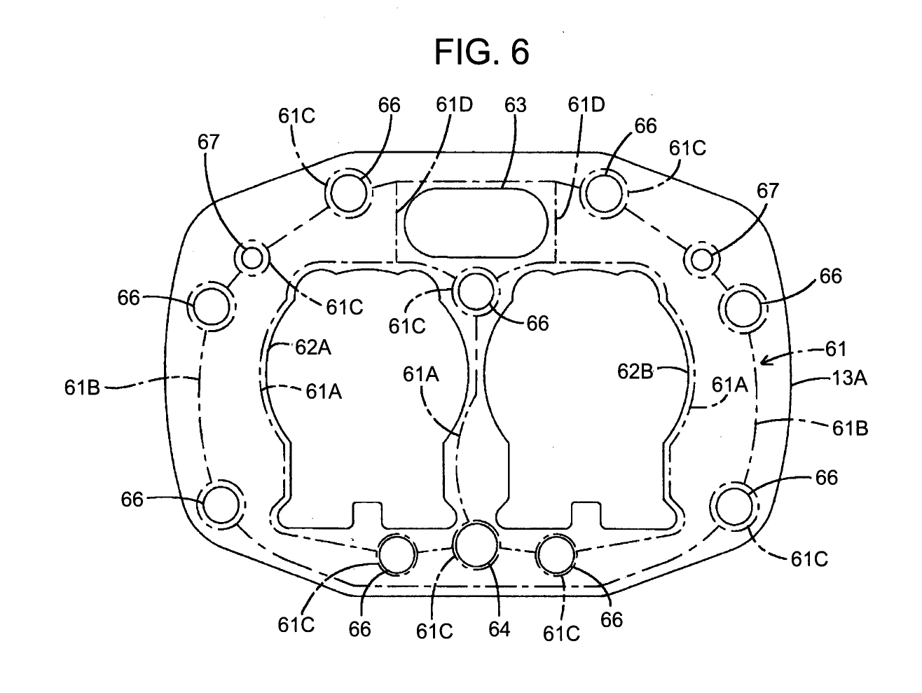

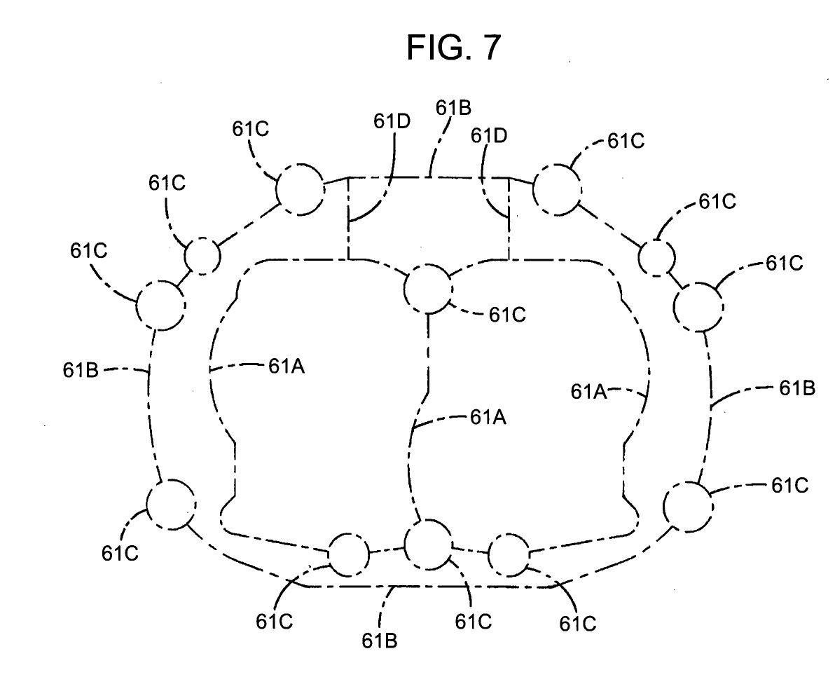

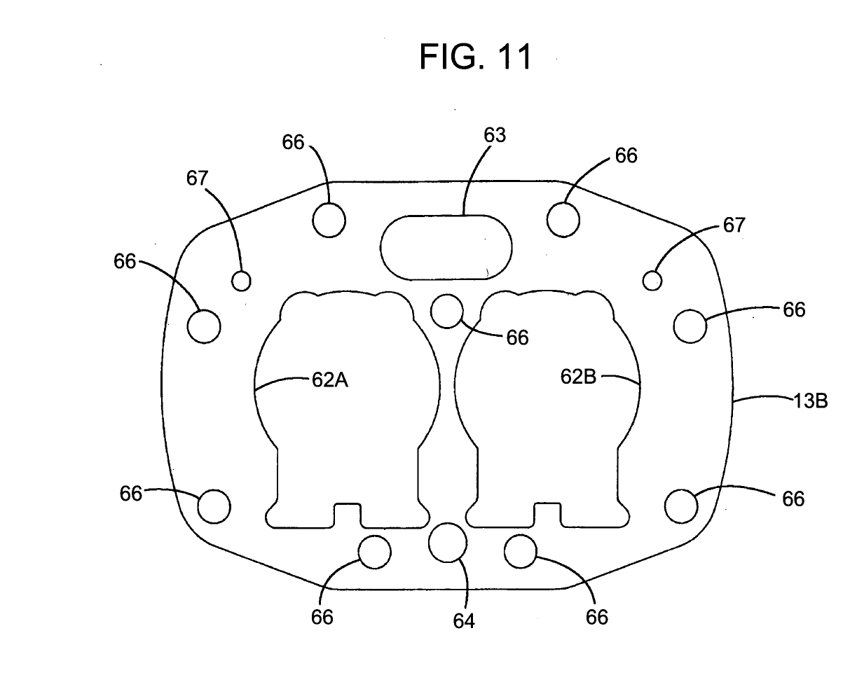

As described above, each of the metal gaskets 13A, 13B is also a plate material constituted by coating the surface of a metal plate such as the cold rolled steel plate (SPCC) or the stainless steel plate (SUS316) with an elastic material such as the nitrile rubber (NBR) having the resistances to high temperature, high pressure and oil. Then, as shown in FIGS. 6 to 11, both the metal gaskets 13A, 13B are provided with cylinder holes 62A, 62B which are arranged in the center of each gasket in a longitudinal direction and which correspond to the cylinders 40A, 40B, and a suction hole 63 and a discharge hole 64 corresponding to the suction port 53 and the discharge port 54, respectively, are formed on one side and the other side of the corresponding wall between both the cylinder holes 62A and 62B. Furthermore, bolt holes 66 through which the bolts 14 are inserted are formed in nine portions in total including eight surrounding portions and one portion of a wall surrounded with the suction hole and the cylinder holes 62A, 62B, and further two positioning holes 67 through which positioning pins (not shown) are inserted are formed.

In this case, the metal gasket 13A is provided with beads 61 as shown in FIGS. 6 to 10, and the metal gasket 13B is not provided with any bead, and is provided in the form of a flat plate (it is to be noted that a metal gasket provided with beads is used in the other seal material 13). In particular, the beads 61 formed on the metal gasket 13A are constituted, as a whole, of two strings of beads including inner beads 61A which surround the cylinder holes 62A, 62B and outer beads 61B which further surround outer peripheries of the inner beads. Moreover, beads 61C are also formed around the discharge hole 64, the bolt holes 66 and the positioning holes 67, the internally positioned discharge hole 64 and three bolt holes 66 continue to the inner beads 61A, and six externally positioned bolt holes 66 and the positioning holes 67 continue to the outer beads 61B. At this time, the beads 61A, 61B are directed toward the centers of the holes 64, 66 and 67 to continue to the beads 61C. In consequence, arrangements are made to apply a uniform force to continued portions. The beads 61A, 61B are formed substantially into circular shapes around the center of the metal gasket 13A as much as possible, and the arrangements are made to apply the uniform force to the beads 61A, 61B as a while.

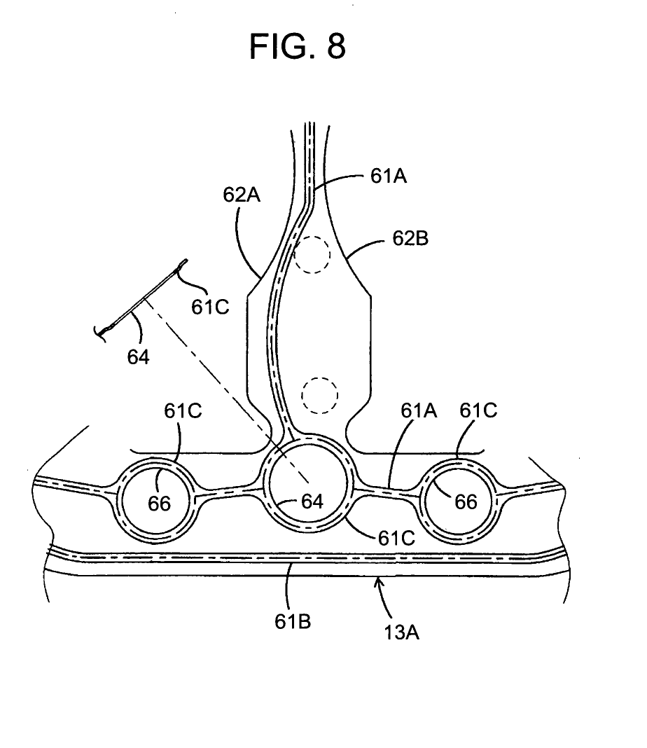

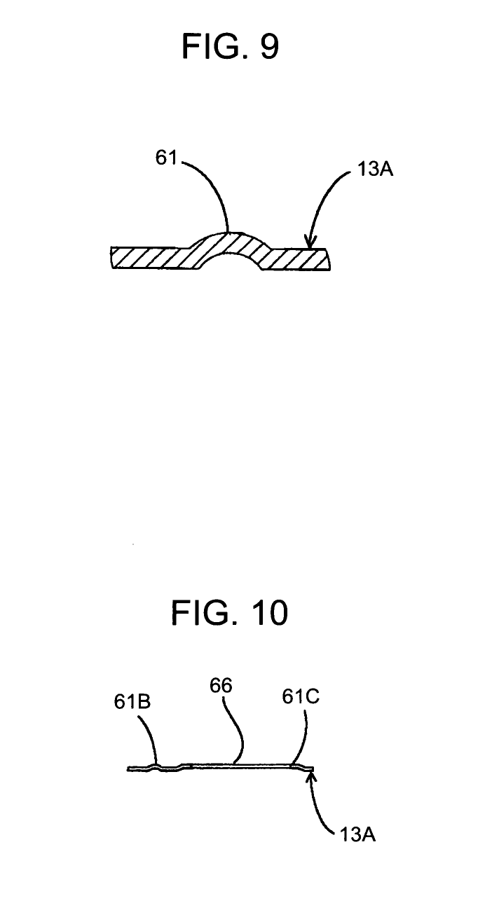

Furthermore, any bead is not formed around the suction hole 63 where the pressure lowers. Instead, beads 61D which connect the inner beads 61A to the outer beads 61B are formed outside the suction hole 63 (on opposite sides in the longitudinal direction). Furthermore, the beads 61C around the discharge hole 64 having a small surrounding wall width (space) and the bolt holes 66 on the opposite sides of the discharge hole are provided in the form of half beads as shown in FIGS. 8 and 10, and the beads 61A, 61B, 61C and 61D of the other portions are provided in the form of full beads as shown in FIG. 9. The beads 61C around the bolt holes 66 are formed in portions corresponding to inner sides (bolt hole 66 sides) from outer edges of the heads of the bolts 14.

Then, in the embodiment, one type of gasket having a plate thickness of 0.38 t is used as the first metal gasket 13A. This plate thickness is such a thickness that the beads can comparatively easily be processed without any trouble. Then, for example, three gaskets having plate thicknesses of 0.3 t, 0.38 t and 0.45 t are prepared as the second metal gasket 13B. Then, the metal gasket 13B having one of the plate thicknesses is selected, superimposed on the metal gasket 13A to adjust the whole dimension, and then nipped between the valve plate 5G and the casing main body 5A, thereby assembling the compressor 1. In consequence, the top clearances between the pistons 41A, 41B and the valve plate 5G are adjusted into optimum values.

At this time, both the metal gaskets are superimposed on each other so that crests of the first metal gasket 13A are disposed on the side of the second metal gasket 13B. Moreover, the second metal gasket 13B is disposed on the valve plate 5G side, and the first metal gasket 13A is disposed on the casing main body 5A side.

Thus, the seal material 13 to be interposed between the valve plate 5G and the casing main body 5A is constituted by superimposing the first metal gasket 13A provided with the beads 61 on the second metal gasket 13B which is not provided with any bead. Therefore, the plate thickness of the second metal gasket 13B which is not provided with any bead is selected for use, whereby the top clearances of the pistons 41A, 41B can be adjusted.

In this case, when the plate thickness of the metal gasket 13A provided with the beads 61 is selected and the plate thickness of the metal gasket 13A increases, it becomes difficult to form the beads 61. That is, according to the present invention, the gasket having such a plate thickness that the beads 61 can comparatively easily be formed is used as the first metal gasket 13A, and the plate thickness of the second metal gasket 13B is selected to adjust the top clearances. In consequence, while the top clearances are easily adjusted using the metal gasket, the beads can be processed without any trouble to securely seal between the valve plate 5G and the casing main body 5A. In a case where the plate thickness of the metal gasket 13A provided with the beads 61 is selected to adjust the top clearances, when the plate thickness of the metal gasket 13A excessively decreases, a spring constant of the metal gasket 13A itself decreases in turn, and a necessary surface pressure cannot be obtained even if the beads 61 are formed. However, in the present invention, the plate thickness of the second metal gasket 13B which is not provided with any bead is selected to adjust the top clearances. Therefore, the plate thickness of the metal gasket 13A provided with the beads 61 is not reduced more than necessary, the spring constant is secured to keep the constant surface pressure provided by the beads, and a seal property can be improved. Moreover, a degree of freedom in the plate thicknesses of both the metal gaskets 13A, 13B increases, so that a complicated shape can easily be realized, and replacement and maintenance can easily be performed.

Furthermore, both the metal gaskets 13A, 13B are superimposed on each other so that the crests of the beads 61 of the first metal gasket 13A are disposed on the side of the second metal gasket 13B, so that the crests of the beads 61 of the first metal gasket 13A abut on the second metal gasket 13B. Therefore, as compared with a case where roots of the beads 61 are allowed to abut on the second metal gasket 13B, a pressure contact strength between both the metal gaskets 13A and 13B increases, and the seal property therebetween improves.

Furthermore, both the metal gaskets 13A, 13B are superimposed on each other so that the second metal gasket 13B is disposed on the valve plate 5G side and the first metal gasket 13A is disposed on the casing main body 5A side. Therefore, the first metal gasket 13A provided with the beads 61 comes in contact under pressure with the casing main body 5A in which surface precision inevitably lowers, and the seal property between the metal gasket 13A and the casing main body 5A can satisfactorily be secured.

Here, when the first metal gasket 13A is disposed on the valve plate 5G side and the second metal gasket 13B is disposed on the casing main body 5A side, a flat surface is provided on the casing main body 5A side having the low surface precision, and hence the seal property lowers as compared with the embodiment. Moreover, when the crests of the beads 61 of the first metal gasket 13A are disposed on the valve plate 5G side in this state, the roots of the beads 61 are disposed between both the metal gaskets 13A and 13B, so that the pressure contact strength between the metal gaskets 13A and 13B lowers as compared with the embodiment. Furthermore, in a case where both the metal gaskets 13A, 13B are provided with the beads, during the superimposition, positions of the beads on the metal gasket 13A side inevitably deviate from those of the beads on the metal gasket 13B side, and hence the seal property becomes unstable. Therefore, the embodiment provides the best arrangement and superimposition.

In addition, in the embodiment, the first metal gasket 13A is provided with the two strings of inner and outer beads 61A, 61B, so that portions of the metal gaskets 13A, 13B having a high pressure contact strength can doubly be constituted outside the cylinders 40A, 40B (the cylinder holes 62A, 62B), and the seal property between the valve plate 5G and the casing main body 5A can remarkably be improved.

Moreover, the beads 61D which connect the two strings of the inner and outer beads 61A, 61B to each other are formed outside the suction hole 63 of the first metal gasket 13A corresponding to the suction port 53 of the valve plate 5G, so that shapes of the beads 61 can be simplified in the portion of the suction port 53 having a low pressure, to improve a processing property.

On the other hand, the beads 61C are formed around the discharge hole 64 of the first metal gasket 13A corresponding to the discharge port 54 of the valve plate 5G and the bolt holes 66 through which the bolts 14 extend, so that the seal property between the discharge port 54 portion when the pressure increases and the bolt 14 portion can be secured.

In particular, the beads 61C around the bolt holes 66 are formed in the portions corresponding to the inner sides from the outer edges of the heads of the bolts 14, so that the beads 61C can be provided in a region to be fastened with the bolts 14, to further improve the seal property around the bolts 14.

### Embodiment 2

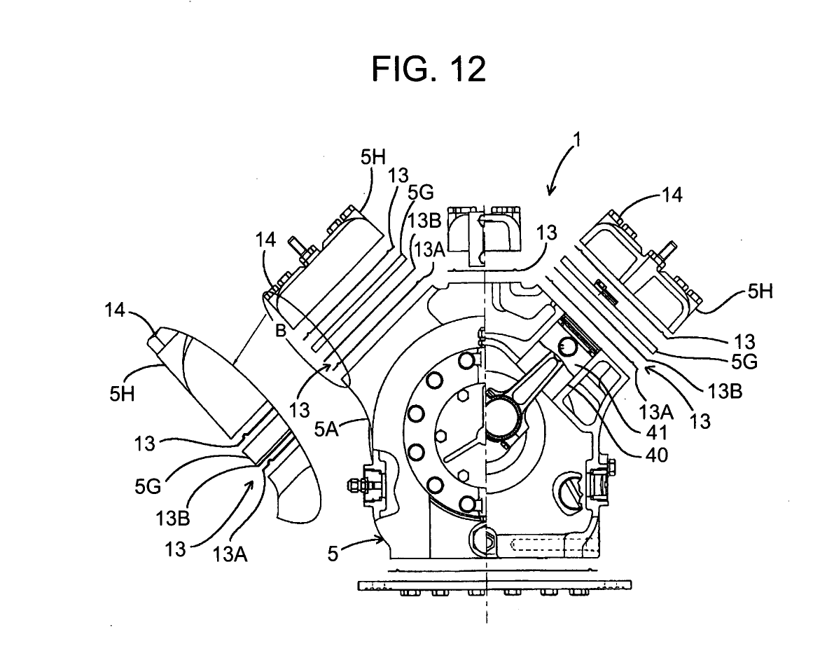

It is to be noted that FIG. 12 is an exploded partially vertical side view showing an example of a V-shaped four-cylinder reciprocation type semi-sealed compressor 1. Even in this case, a casing main body 5A is provided with four cylinders 40, and pistons 41 are received in the cylinders, respectively. Then, a seal material 13 constituted by superimposing metal gaskets 13A, 13B on each other as described above is interposed between the casing main body 5A and a valve plate 5G of each cylinder head 5H. The present invention is effective even in such a V-shaped compressor 1.

Moreover, in the above embodiments, two metal gaskets (the first metal gasket 13A and the second metal gasket 13B) are superimposed on each other and interposed between the valve plate 5G and the casing main body 5A, but the present invention is not limited to these embodiments, and three or more metal gaskets (including a case where all the gaskets have an equal plate thickness or one or all of the gaskets has a different thickness) may be superimposed on one another to adjust top clearances. Even in this case, needless to say, it is preferable that beads are formed on the metal gasket having such a plate thickness that the beads can easily be formed, and the metal gaskets are superimposed on one another so that a metal gasket provided with the beads is disposed on the side of the casing main body 5A, a metal gasket which is not provided with any bead is disposed on the side of crests of the beads, and another metal gasket provided with the beads is disposed on the valve plate 5G side of the gasket which is not provided with any bead.

Furthermore, in the embodiments, the plate thickness of the second metal gasket 13B which is not provided with the beads 61 is selected to adjust the top clearances, but the metal gaskets provided with the beads 61 and having a plurality of thicknesses may be prepared, to select the first metal gasket 13A for use from them. In addition, in the embodiment, it has been described in the present invention that the metal gasket provided with the beads is superimposed on the metal gasket which is not provided with any bead, but according to the present invention of the first or ninth aspect, a plurality of metal gaskets which are all not provided with the beads may constitute the seal material 13 between the valve plate 5G and the casing main body 5A to adjust the top clearances.

Then, in the embodiments, the present invention has been described in accordance with the example of a two-cylinder or four-cylinder single-stage semi-sealed compressor, but the present invention is not limited to the example, and is effectively applicable even to a multistage compression type (especially, a type in which a carbon dioxide catalyst is used) semi-sealed compressor.

1. A compressor in which pistons reciprocate in cylinders of a casing main body constituting a casing perform a compression work and which is constituted by 5 fixing cylinder heads with bolts to the casing main body via a seal material and a valve plate,
wherein the seal material to be interposed between the valve plate and the casing main body is constituted by superimposing a plurality of metal gaskets on one another.

2. The compressor according to claim 1, wherein among the plurality of metal gaskets, a first metal gasket is provided with beads, and a second metal gasket is not provided with any bead.

3. The compressor according to claim 2, wherein both 15 the metal gaskets are superimposed on each other so that crests of the beads of the first metal gasket are disposed on the side of the second metal gasket.

4. The compressor according to claim 2 or 3, wherein both the metal gaskets are superimposed on each other so 20 that the second metal gasket is disposed on the side of the valve plate, and the first metal gasket is disposed on the side of the casing main body.

5. The compressor according to claim 2 or 3, wherein the first metal gasket is provided with two inner 25 and outer strings of beads.

6. The compressor according to claim 2 or 3, wherein the metal gaskets are provided with suction holes corresponding to a suction port of the valve plate, and the first metal gasket is provided with beads which connect the two inner and outer strings of beads to each other outside the suction holes.

7. The compressor according to claim 2 or 3, wherein the metal gaskets are provided with discharge holes corresponding to a discharge port of the valve plate, and bolt holes through which the bolts extend, and the first metal gasket is provided with the beads around the discharge holes and the bolt holes.

8. The compressor according to claim 7, wherein the beads around the bolt holes are formed in portions corresponding to inner sides from outer edges of heads of the bolts.

9. A manufacturing method of a compressor in which pistons reciprocate in cylinders of a casing main body constituting a casing to perform a compression work and which is constituted by fixing cylinder heads with bolts to the casing main body via a seal material and a valve plate, the method comprising:
superimposing a plurality of metal gaskets on one another to constitute the seal material to be interposed between the valve plate and the casing main body; and selecting one or the plurality of metal gaskets for use from metal gaskets having a plurality of plate thicknesses to adjust top clearances of the pistons.

10. The manufacturing method of the compressor according to claim 9, wherein the metal gasket having the plate thickness selected for the adjustment of the top clearances is not provided with any bead, and a metal gasket other than the metal gasket is provided with beads.
